(19) United States
(12) Patent Application Publication
(10) Pub. No.: US 2006/0234196 A1
(43) Pub. Date: Oct. 19, 2006

(54) Method and apparatus for body part filters of comparison studies

(75) Inventors: Benjamin D. Novatzky, Oak Park, IL (US); Richard W.I. Yarger, Berkeley, IL (US); Kengo Baba, Evanston, IL (US); James Jay, Lake Villa, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/108,287

(22) Filed: Apr. 18, 2005

(51) Int. Cl. G09B 23/28

(52) U.S. Cl. 434/262

(57) ABSTRACT

A system and method to increase the efficiency and effectiveness of a radiologist. In a medical imaging systems, a user may typically compare images of a patient from a current study with images of the patient from a previous study. A user may use several body part filters to retrieve studies applicable to a current study. A first filter may have a search set of available body parts, essentially returning available studies of the patient. A second filter may have a search set corresponding to the body parts of the current study. A third set of filters may have a search set corresponding to one body part of a current study. Each filter in the third set may have a distinct search set comprising one of the body parts of the current study. A fourth set of filters may have a search set defined by the user.

### BACKGROUND OF THE INVENTION

The present invention generally relates to a system and method for improved medical imaging. Particularly, the present invention relates to a more efficient system and method for organizing and interpreting medical images.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

An example of a medical diagnostic imaging system is Picture Archival Communication Systems (PACS). PACS is a term for equipment and software that permits images and information, such as x-rays, ultrasound, CT, MRI, EBT, MR, or nuclear medicine for example, to be electronically acquired, stored and transmitted for viewing. Images from an exam may be viewed immediately, stored, or transmitted. The images may be viewed on diagnostic workstations by users, for example radiologists.

In general, images may be acquired as part of an imaging procedure. An imaging procedure may be a procedure to acquire images of various body parts for subsequent examination and/or study. Currently, thousands of imaging procedures exist, each procedure designed to provide images of various body parts. The imaging procedures may also provide images of various body parts at distinct angles of view. For example, a whole body scan may yield images of the whole body of a patient. A hand procedure may yield images of a patient's hand. An upper body procedure may yield images of the head, neck, and spine.

As mentioned above, images acquired as part of an exam or study may be stored for subsequent viewing. In one application, a user may compare a previous study of a patient with a current study of a patient. In such a manner, objects may be monitored over the course of time. For example, a user may wish to compare a current study of a patient's lungs and chest with previous images of the patient's lungs and chest. Generally, in order for a user to locate archived images the user may have to review and search through the patient's available studies. A user may have to retrieve all available previous studies of a patient, and then review and search the available studies for the desired images. In the example above, in order for a user to locate previous images of a patient's lungs and chest, the user may have to review and search the available previous studies for images of the patient's lungs and chest.

If a patient has a relatively small number of previous studies, the burden on a user to locate an applicable study may be minor. However, if a patient has many previous studies, the burden on a user to locate an applicable study may be severe. Accordingly, a need exists for the ability of a user to efficiently organize and select archived studies of a patient.

Therefore, a need exists for a system and method that increases the efficiency of a user seeking to locate an appropriate archived study. Such a system and method may increase the efficiency of a user studying medical imaging examinations. Such a system and method may also organize the previous images to provide clarity to a user of the information provided in the previous images. Such a system and method may also provide flexibility of viewing archived studies to enhance workflow.

### SUMMARY OF THE INVENTION

Certain embodiments of the present invention provide a system and method for organizing medical studies. In an embodiment, a computer unit executes computer software that organizes the medical imaging studies. The computer software includes at least one filter. The filter has a search set corresponding to one body part of a current study. The system also includes a display unit for displaying user interface corresponding to the filter. The current study may be selected by a user or by the computer unit. If the current study is selected by the computer unit, the computer unit may select the most recent study available for a patient. Also, the number of filters may correspond to the number of body parts in the current study. Each filter may have a distinct search set comprising one of the body parts of the current study. The body parts may be from a static mapping of the study's performed procedure to one or more body parts. Alternatively, body parts may come from DICOM tags that are associated with the DICOM objects of the study. Additionally, user the interface may include a comparison icon for identifying filters having a search set that includes at least one body part in common with the current study.

Certain embodiments also include a computer unit for executing computer software that organizes the medical imaging studies. The computer software includes at least one filter. The filter has a search set of at least one body part defined by a user. The system also includes a display unit for displaying the user interface corresponding to filter. Moreover, the user interface may include a comparison icon for identifying filters having a search set including at least one body part in common with a current study. The user interface may also include a user defined icon for identifying filters having a search set defined by the user.

Certain embodiments also include a computer unit for executing computer software that organizes the medical imaging studies. The computer software including a first filter that has a search set of all body parts, a second filter having a search set of body parts of a current study, at least one third filter having a search set of one body part of the current study. The system also includes a display unit for displaying a user interface corresponding to said filter. Moreover, the system may comprise at least one additional fourth filter having a search set of at least one body part defined by a user. The current study may be selected by a user or by the computer unit. If the current study is selected by the computer unit, the computer unit may select the most recent study available for a patient. Also, the number of filters may correspond to the number of body parts in the current study. Each filter may have a distinct search set comprising one of the body parts of the current study. Additionally, the interface may include a comparison icon for identifying filters having a search set that includes at least one body part in common with the current study. The user interface may also include a user defined icon for identifying filters having a search set defined by the user.

Certain embodiments of the present invention provide a method for displaying medical images. The method includes first selecting a current study. Then selecting a first filter having a search set of a single body part. The body part being defined by the current study, or selecting a second filter having a search set of at least one body part defined by a user. Finally, the method includes selecting a study to view. The current study may be selected by a user or by the computer unit. If the current study is selected by the computer unit, the computer unit may select the most recent study available for a patient. Also, the number of filters may correspond to the number of body parts in the current study. Each filter may have a distinct search set comprising one of the body parts of the current study.

Certain embodiments also include a computer-readable storage medium including a set of instructions for a computer. The set of instructions include a first selection routine for selecting a current study. The set of instructions also include a second selection routine for selecting a first filter having a search set of a single body part. The body part being defined by the current study, or selecting a second filter having a search set of at least one body part defined by a user. The set of instructions also includes a third selection routine for selecting a study to view.

### BRIEF DESCRIPTION OF THE DRAWINGS

FIG. 1 illustrates an example of a medical imaging system which may be used in accordance with an embodiment of the present invention.

FIG. 2 illustrates a graphical application representing a chart of available studies of a hypothetical Patient A which may be used with the system illustrated in FIG. 1 in accordance with an embodiment of the present invention.

FIG. 3 illustrates a graphical application representing a user interface that may be presented to a user of the system illustrated in FIG. 1 in accordance with an embodiment of the present invention.

FIG. 4 illustrates a graphical application representing an expanded user interface as illustrated in FIG. 3 that may be presented to a user of the system illustrated in FIG. 1 in accordance with an embodiment of the present invention.

FIG. 5 illustrates a graphical application representing an expanded user interface as illustrated in FIG. 3 that may be presented to a user of the system illustrated in FIG. 1 in accordance with an embodiment of the present invention.

FIG. 6 illustrates a graphical application representing an expanded user interface as illustrated in FIG. 3 that may be presented to a user of the system illustrated in FIG. 1 in accordance with an embodiment of the present invention.

FIG. 7 illustrates a graphical application representing an expanded user interface as illustrated in FIG. 3 that may be presented to a user of the system illustrated in FIG. 1 in accordance with an embodiment of the present invention.

FIG. 8 illustrates a method that may be used in accordance with an embodiment of the present invention.

### DETAILED DESCRIPTION OF THE INVENTION

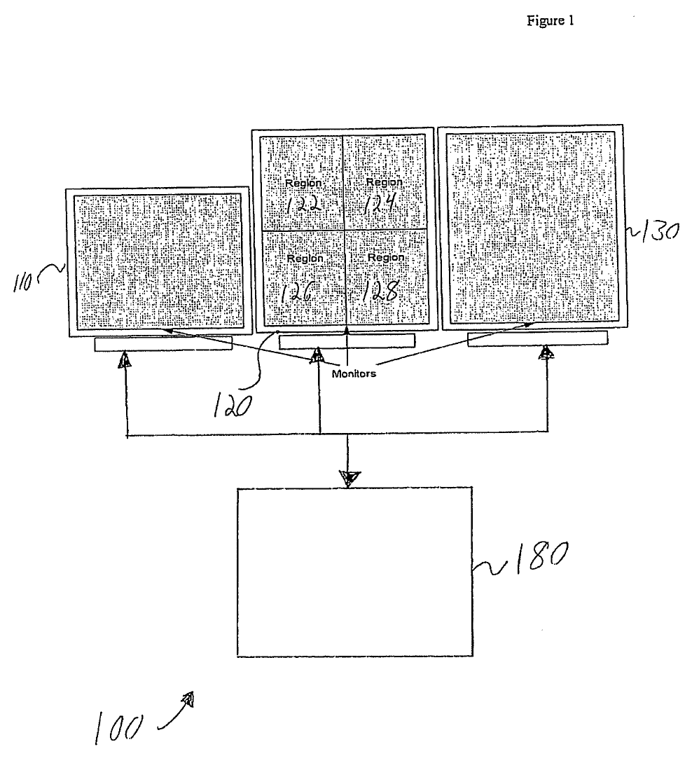

FIG. 1 illustrates a system 100, which is example of a medical imaging system which may be used in accordance with an embodiment of the present invention. As an example, the system 100 shows three display units, unit 110, unit 120, and unit 130. The display units may be, for example, computer monitors. Units 110 and 130 include a single display region. In an embodiment, images of a current study and a comparison study may be displayed on display units 110 and 130, respectively. Unit 120 includes four display regions, 122, 124, 126, and 128, respectively.

Also included in the system 100 is a computer unit 180. The computer unit 180 may be equipment or software that permits electronic medical images, such as x-rays, ultrasound, CT, MRI, EBT, MR, or nuclear medicine for example, to be electronically acquired, stored, or transmitted for viewing and/or operation. The computer unit 180 may be connected to other devices as part of an electronic network and also in electrical communication with the display units 110-130.

In an embodiment, the computer unit 180 may be, or may be part of, a picture archival communication system (PACS). For example, the system 100 may be a PACS with display units 110, 120, and 130 representing the display units of a PACS. Moreover, the computer unit 180 may represent equipment that may be generally associated with PACS, including input controls, communication processing and storage equipment. Alternatively, the computer unit 180 and display units 110, 120, and 130 may be separate units. In such a case, the display units 110, 120, and 130 may be in electrical communication with the computer unit 180. The components of the system 100 may be single units, separate units, may be integrated in various forms, and may be implemented in hardware and/or in software.

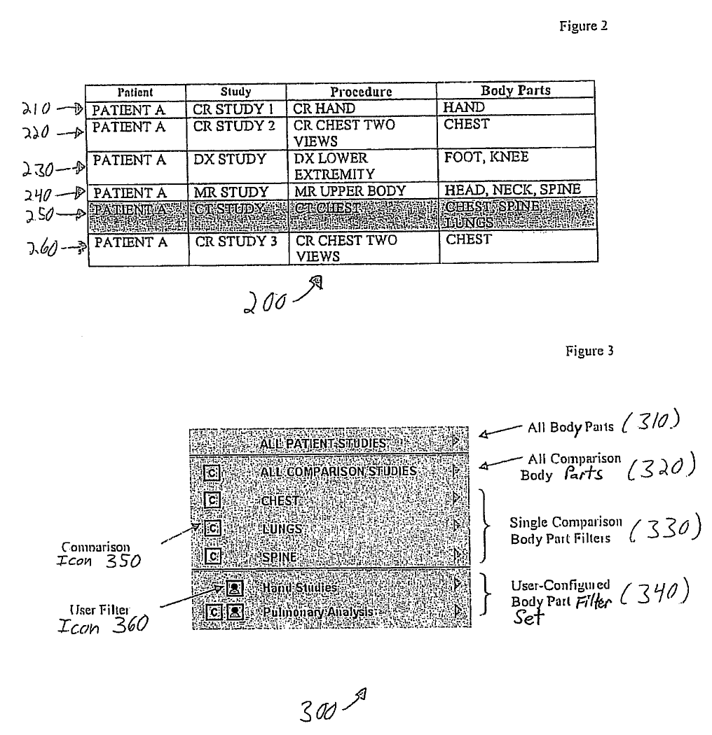

FIG. 1 is just an example, and a greater number or lesser number of displays may be used in accordance with the present invention. In an embodiment, a single display unit may be used with the present invention. FIGS. 2-7 are discussed with reference to FIG. 1 as an example of an embodiment of the present invention. Various hanging protocols may be used, however, and any combination, including additions and/or deletions of images may be displayed in accordance with the present invention. FIGS. 2-7 are generally graphical applications that may be displayed on the display units 110-130. In an embodiment, the graphical applications of FIGS. 2-7 may be displayed on display unit 120. The current and comparison studies may be displayed on display units 110 and 130. Alternatively, a single display unit may display both the current and comparison studies as well as the graphical application of FIGS. 2-7.

FIG. 2 illustrates a graphical application representing a chart of available studies of a hypothetical Patient A which may be used with the system 100 in accordance with an embodiment of the present invention. The graphical application chart 200 may be displayed on any of the display units 110-130 in FIG. 1. For example, the chart 200 may be displayed on region 122 of display unit 120. Alternatively, the chart 200 may not be displayed to a user, but the information contained in the chart may be available to the user. Regardless of display, the chart 200 is used as an example to explain an embodiment of the present invention. The chart of available studies 200 includes six studies 210-270 respectively, of Patient A. Although only six studies are shown, the number of studies can be any number and of any type.

The first column of the chart 200 identifies the patient. The second column of the chart 200 identifies the type of study done on the patient. The third column of the chart 200 identifies the procedure done as part of the study identified in column 2. The final column identifies the body parts involved in the study. For example, images of Patient A's hand are located in study 210. Images of Patient A's chest are located in studies 220, 250, and 260. The body parts may be from a static mapping of the study's performed procedure to one or more body parts. For example, the procedure DX LOWER EXTREMITY of study 230 may be mapped to body parts FOOT and KNEE. The mapping may be defined prior to opening studies and be stored at computer unit 180. Alternatively, body parts may be from DICOM tags. The DICOM tags may be associated with the DICOM objects of the study. For example, the body parts may be from the DICOM tag (0018,0015) Body Part Examined.

A user may locate images applicable for comparison by filtering the available studies by body part. For example, in reference to FIG. 2, a body part filter on {spine} would yield studies {MR STUDY (240), CT STUDY (250)}. In another example, a body part filter on {chest, spine} would yield studies {CR STUDY 2 (220), MR STUDY (240), CT STUDY (250), CR STUDY 3 (260)}. Accordingly, a body part filter may be an OR filter returning a study if the study contains at least one image of one of the requested body part(s).

In the embodiment of FIG. 2, a user may select a study for review. The study selected by a user may be the current study for review. Alternatively, the computer unit 180 may select the most recent study as the current study. As a study is selected as the current study, the body parts of that study may be selected as the current study body parts. For example, if study 250 is selected as the current study, then the body parts chest, spine, and lungs are selected as the current body parts. As an example and in further explanation of an embodiment of the present invention, study 250, the shaded study in FIG. 1, has been selected as the current study. In the embodiment where the chart 200 is displayed to the user, the current study may also be highlighted or noted.

FIG. 3 illustrates a graphical application representing a user interface 300 presented to a user of the system 100 and chart 200 in accordance with an embodiment of the present invention. The interface 300 may be displayed by the system 100 on any of the display units 110-130 in FIG. 1. For example, the interface 300 may be displayed on region 126 of display unit 120. Alternatively, the interface 300 may be part of a menu that is displayed upon user request.

The interface 300 includes four types of body part filters. The four filters shown in FIG. 3 are filters 310-340. Filter 310 is labeled ALL PATIENT STUDIES on the interface 300, also referred to as All Body Parts 310. Filter 320 is labeled ALL COMPARSION STUDIES on the interface 300, also referred to as All Comparison Body Parts 320. The filter 330 is a set of Single Comparison Body Part Filters 330 and has three sub-filters, 330(a), 330(b), and 330(c). The set of filters 330(a) is labeled CHEST on the interface 300. The filter 330(b) is labeled LUNGS on the interface 300. The filter 330(c) is labeled SPINE on the interface 300. The filter 340 is a set of filters referred to as User-Configured Body Part Set 340. The filter 340 has two sub-filters, 340(a) and 340(b). The filter 340(a) is labeled Hand Studies on the interface 300. The filter 340(b) is labeled Pulmonary Analysis on the interface 300. The set of filters 340 is also referred to as User-Configured Body Part Filter Set 340. Also shown in FIG. 3 are a comparison icon 350 and a user filter icon 360. The comparison icon 350 is represented by a box with a “c” and the user filter icon 360 is represented by a box containing an outline of a user. The interface 300 as displayed and described in FIG. 3 is only an example. Accordingly, the interface 300 may look substantially different based on the body parts of the current study as well as the filters configured by a user.

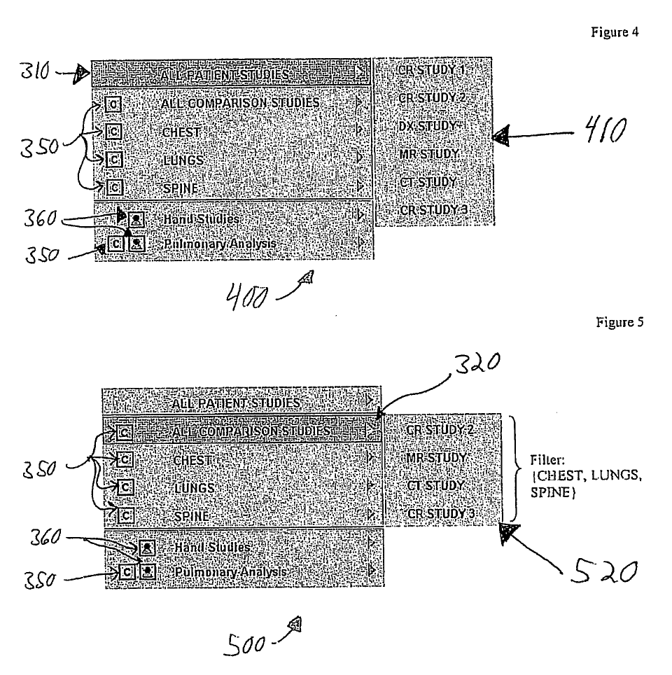

FIG. 4 illustrates a graphical application representing a user interface 400 presented to a user of the system 100. The interface 400 is an expanded version of the interface 300 and may be displayed by the system 100 on any of the display units 110-130 in FIG. 1. For example, the interface 400 may be displayed on regions 126 and 128 of display unit 120. Alternatively, the interface 400 may be part of a menu that is displayed upon user request.

FIG. 4 illustrates an expansion 410 of the interface 300 when a user selects the ALL PATIENT STUDIES filter 310, as is indicated by the shading of FIG. 4. The ALL PATIENT STUDIES filter 310 has a search set of all body parts. Accordingly, the ALL PATIENT STUDIES filter returns available studies for a particular patient. In the ongoing example, available studies for Patient A are the six studies 210-270. Therefore, in the example, the ALL PATIENT STUDIES filter returns studies 210-270, as shown in FIG. 4. The string ALL PATIENT STUDIES is only an example and any string may be used to convey the meaning of the filter to the user.

FIG. 5 illustrates a graphical application representing a user interface 500 presented to a user of the system 100. The interface 500 is an expanded version of the interface 300 and may be displayed by the system 100 on any of the display units 110-130 in FIG. 1. For example, the interface 500 may be displayed on regions 126 and 128 of display unit 120. Alternatively, the interface 500 may be part of a menu that is displayed upon user request.

FIG. 5 illustrates an expansion 520 of the interface 300 when a user selects the ALL COMPARISION STUDIES filter 320, as is indicated by the shading of FIG. 5. The ALL COMPARISON STUDIES filter 320 has a search set of body parts within the current study. In other words, the search set of the ALL COMPARISON STUDIES filter 320 may be the current body parts. Accordingly, the ALL COMPARISION STUDIES filter 320 returns studies having at least one body part that matches the body part(s) of the current study. For example, the current study in the ongoing example is the study 150 from FIG. 1. Study 150 contains body parts chest, spine, and lungs, as is identified in FIG. 5. Accordingly, the ALL COMPARISON STUDIES filter 320 has a search set {chest, spine and lungs} and returns the studies which have body parts chest, spine, or lungs. As shown in FIG. 5, studies CR STUDY 2, MR STUDY, CT STUDY, AND CR STUDY 3 are returned because the studies contain at least one of the current body parts.

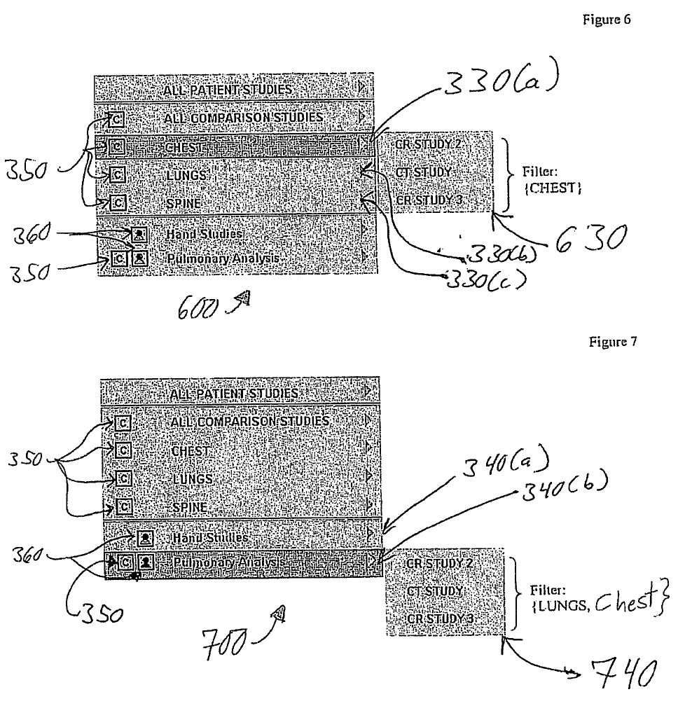

FIG. 6 illustrates a graphical application representing a user interface 600 presented to a user of the system 100. The interface 600 is an expanded version of the interface 300 and may be displayed by the system 100 on any of the display units 110-130 in FIG. 1. For example, the interface 600 may be displayed on regions 126 and 128 of display unit 120. Alternatively, the interface 600 may be part of a menu that is displayed upon user request.

FIG. 6 illustrates an expansion 630 of the interface 300 when a user selects one of the Single Comparison Body Part Filters 330(a-c). In an embodiment, a Single Comparison Body Part Filter 330 is created according to the body parts available in the current study. A Single Comparison Body Part Filter 330 may be created for the body parts of the current study. In an embodiment, a Single Comparison Body Part Filter 330 is created for each body part within the current study. Accordingly, the number of Single Comparison Body Part Filters 330 may equal the number of body parts within the current study. The search set of each Single Comparison Body Part Filter 330 may correspond to a single body part within the current study.

For example, the interface 300 illustrates three Single Comparison Body Part Filters 330(a-c), CHEST, LUNGS, and SPINE respectively. The individual body parts available in the current study 250 in FIG. 2 are the chest, spine, and lungs. Accordingly, in an embodiment, the Single Comparison Body Part Filters 330(a-c) correspond to the individual body parts available in the current study 250. If, in another example, the current study of FIG. 2 was changed to study 230, the Single Comparison Body Part Filters 330 may consist of one filter for FOOT and one filter for KNEE.

In FIG. 6, a user has selected filter 330(a), the CHEST filter, as is indicated by the shading of CHEST in FIG. 6. Accordingly, studies having the body part chest are returned to the user: CR STUDY 2, CT STUDY, AND CR STUDY 3. A user interested in chest images has the available chest images of Patient A in an efficient manner. Although not shown, filter 230(b) for LUNGS would return CT STUDY, as the study is the only study in this example to have the body part of lungs. Also, filter 230(c) for SPINE would return MR STUDY, CT STUDY, as these studies are the only studies in the example to have body part of spine.

FIG. 7 illustrates a graphical application representing a user interface 700 presented to a user of the system 100. The interface 700 is an expanded version of the interface 300 and may be displayed by the system 100 on any of the display units 110-130 in FIG. 1. For example, the interface 700 may be displayed on regions 126 and 128 of display unit 120. Alternatively, the interface 700 may be part of a menu that is displayed upon user request.

FIG. 7 illustrates an expansion 740 of the interface 300 when a user selects one of the User Configured Body Part Filter Sets 340(a-b). In an embodiment, a User Configured Body Part Filter 340 may be created according to the body parts as defined by a user. The User Configured Body Part Filter Sets 340 are different from the filters 310-330 in that the search set of body parts for filters 310-330 is defined by the body parts of the current study. The search set of body parts for filter 340 is defined by the user and does not necessarily include any of the body parts of the current study.

For example, in FIG. 3, two User Configured Body Part Filters are shown, 340(a) Hand Studies and 340(b) Pulmonary Analysis. In the Hand Studies filter 340(a), the user has defined a filter to include the body part of the hand. In the example, the body part of the hand is not in the current study 250 of FIG. 2. However, if a user were to highlight the Hand Studies filter, the filter would return study 210, as study 210 is the only study having a body part of the hand. Also note to the left of the Hand Studies graphic in FIGS. 3-7 is a user defined icon 360. The user defined icon 360 indicates the user has defined the search set for the filter next to the icon. In this case, the user has defined the Hand Studies filter to include the body part of the hand.

In the Pulmonary Analysis filter 340(b), the user has defined the search set as lungs and chest. Notice that the search set is different from the current study 250 of FIG. 2 which includes CHEST, SPINE, and LUNGS. In the case of FIG. 7, the user has chosen to define a filter with a search set of lungs and chest and name the filter Pulmonary Analysis. Also note, similar to the Hand Studies filter, the user defined icon 360 next to the Pulmonary Analysis filter. The user defined icon 360 indicates the user has created the filter and has not relied on the current study body parts to define the search set. However, in contrast to the Hand Studies filter, the Pulmonary Analysis filter also has the comparison icon 350. The comparison icon 350 indicates the search set of body parts has at least one body part in common with the current study. For example, the current study 350 has a search set of body parts of chest, spine, and lungs. The user has defined the Pulmonary Analysis filter as having a search set of body parts of lungs and chest. Therefore, the studies returned from the Pulmonary analysis filter may allow a user to compare the studies to the current study 250. Moreover, the comparison icon 350 also appears next to the ALL COMPARISION STUDIES 320, and the Single Comparison Body Part Filters 330. The comparison icon 350 indicates that the filter may provide images of at least one body part in common with the body parts of the current study.

The Hand Studies filter 340(a) and Pulmonary Analysis filter 340(b) are only examples. A user may configure the customizable filters in any fashion and any number of custom filters may be created. Also, any combination of body parts may be created in the filters.

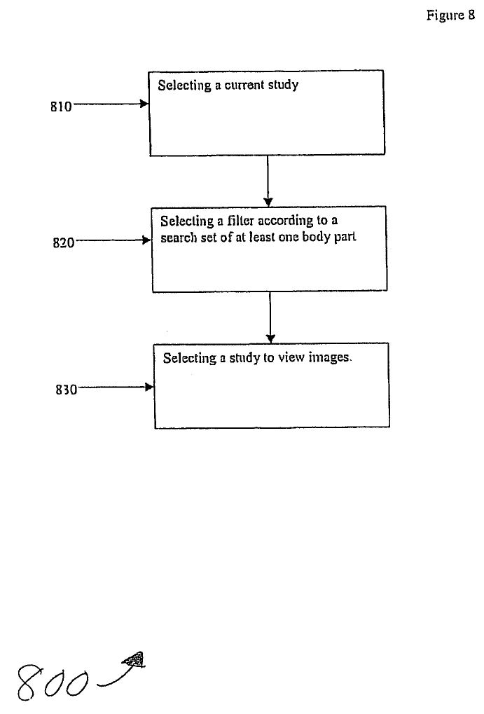

FIG. 8 illustrates a method 800 in accordance with an embodiment of the present invention. At step 810, a user may select a study as a current study. Alternatively, the current study may be automatically selected as the most recent study for a particular patient. At step 820, a user may select a filter according to a search set of at least one body part. The search set may be defined by all body parts, the body parts available in the current study, individual body parts available in the current study, or may be defined by at least one body part defined by a user. Finally, at step 830, a user may select a study to view images.

The system and method described above may be carried out as part of a computer-readable storage medium including a set of instructions for a computer. The set of instructions includes a first selection routine for selecting a current study. In an embodiment, the user may select the current study. Alternatively, the routine may select the most recent study for a particular patient as the current study. The set of instructions also includes a second selection routine for selecting a filter according to a search set of at least one body part. The search set may be defined by all body parts, the body parts available in the current study, individual body parts available in the current study, or may be defined by at least one body part defined by a user. The set of instructions also includes a third selection routine to select a study for viewing the images.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for organizing medical imaging studies, said system comprising:
a computer unit for executing computer software that organizes said medical imaging studies, said computer software including at least one filter, said filter having a search set corresponding to one body part of a current study; and
a display unit for displaying a user interface corresponding to said filter.

2. The system of claim 1, wherein the current study is selected by a user.

3. The system of claim 1, wherein the current study is selected by the computer unit as the most recent study available for a patient.

4. The system of claim 1, wherein the number of filters corresponds to the number of body parts of the current study, each filter having a distinct search set comprising one of the body parts of the current study.

5. The system of claim 1, wherein said user interface includes a comparison icon for identifying filters having a search set including at least one body part of the current study.

6. A system for organizing medical imaging studies, said system comprising:
a computer unit for executing computer software that organizes said medical imaging studies, said computer software including at least one filter, said filter having a search set of at least one body part defined by a user; and
a display unit for displaying a user interface corresponding to said filter.

7. The system of claim 6, wherein said user interface includes a comparison icon for identifying filters having a search set that includes at least one body part of a current study.

8. The system of claim 6, wherein said user interface includes a user defined icon for identifying filters having a search set defined by a user.

9. A system for organizing medical imaging studies, said system comprising:
a computer unit for executing computer software that organizes said medical imaging studies, said computer software including a first filter having a search set of available body parts, a second filter having a search set of body parts of a current study, at least one third filter having a search set of one body part of the current study; and
a display unit for displaying a user interface corresponding to said filters.

10. The system of claim 9, further comprising at least one fourth filter having a search set of at least one body part defined by a user.

11. The system of claim 9, wherein the current study is selected by a user.

12. The system of claim 9, wherein the current study is selected by the computer unit as the most recent study available for a patient.

13. The system of claim 9, wherein the number of third filters corresponds to the number of body parts of the current study, each filter having a distinct search set comprising one of the body parts of the current study.

14. The system of claim 9, wherein said user interface includes a comparison icon for identifying filters having a search set that includes at least one body part of the current study.

15. The system of claim 9, wherein said user interface includes a user defined icon for identifying filters having a search set defined by a user.

16. A method for displaying medical images, said method comprising:
selecting a current study;
selecting a first filter having a search set of a single body part, said body part being defined by the current study, or selecting a second filter having a search set of at least one body part, said body part being defined by a user; and
selecting a study to view.

17. The method of claim 16, wherein the current study is selected by a user.

18. The method of claim 16, wherein the current study is selected by the computer unit as the most recent study available for a patient.

19. The method of claim 16, wherein the number of first filters corresponds to the number of body parts of the current study, each filter having a distinct search set comprising one of the body parts of the current study.

20. A computer-readable storage medium including a set of instructions for a computer, the set of instructions comprising:
a first selection routine for selecting a current study;
a second selection routine for selecting a first filter having a search set of a single body part, said body part being defined by the current study, or selecting a second filter having a search set of at least one body part, said body part being defined by a user; and
a third selection routine for selecting a study to view.
